(19) United States
(12) Patent Application Publication
(10) Pub. No.: US 2010/0014898 A1
(43) Pub. Date: Jan. 21, 2010

(54) FIXING DEVICE AND IMAGE FORMING APPARATUS EMPLOYING THE SAME

(75) Inventor: Eiji Nakajima, Osaka-shi (JP)

Correspondence Address: CASELLA & HESPOS, 274 MADISON AVENUE, NEW YORK, NY, 10016, US

(73) Assignee: KYOCERA MITA CORPORATION, Osaka-shi (JP)

(21) Appl. No.: 12/504,504

(22) Filed: Jul. 16, 2009

(30) Foreign Application Priority Data
Jul. 18, 2008 (JP) 2008-187195

(51) Int. Cl. G03G 15/20

(52) U.S. Cl. 399/322

(57) ABSTRACT

A fixing device includes a fixing member, a pressure member pressed against the fixing member, a separating member disposed at a specific distance from the fixing member for separating a printing sheet therefrom after the printing sheet has passed through a nip portion formed between the fixing member and the pressure member, the separating member being made movable in directions toward and away from the fixing member, and a movement restricting member for limiting movement of the separating member in the direction away from the fixing member.

### BACKGROUND OF THE INVENTION

1. Field of the Invention

The present invention relates to an image forming apparatus, such as a copying machine, a printer, a facsimile machine or a hybrid apparatus thereof, as well as to a fixing device used in an image forming apparatus.

2. Description of the Background Art

Generally, a conventional electrophotographic color image forming apparatus is configured to visualize an electrostatic latent image formed on a photosensitive member into a toner image, transfer the toner image to a printing sheet, and fix the toner image to the printing sheet by passing the printing sheet through a fixing device. As an example, a fixing device includes a heatable fixing roller (fixing member) and a pressure roller (pressure member) which is pressed against the fixing roller. The toner image is fixed to the printing sheet as the printing sheet is passed through a nip portion formed between these two rollers.

One problem which may occur when the printing sheet is passed through the nip portion between the fixing roller and the pressure roller is that toner on the printing sheet fuses and, as a result, the printing sheet wraps around the fixing roller. There exist conventionally known arrangements intended to overcome this problem. One of such conventional arrangements is a fixing device provided with a separating member for separating the printing sheet from the fixing roller after the printing sheet has passed through the nip portion.

For example, Japanese Unexamined Patent Publication No. 2004-361612 describes a fixing device provided with a separating member of the aforementioned kind. The fixing device of this Publication includes a separator having the separating member at a far end, in which the separating member is made swingable in directions toward and away from a fixing roller. The separating member thus configured serves to separate each printing sheet which has passed through the nip portion from the fixing roller.

If a large quantity of toner adheres to the printing sheet or the toner has high tackiness, however, the fixing device of the aforementioned Publication can produce a problem that the printing sheet becomes bent in a U-shape and goes into a gap between the fixing roller and the separating member. As a result of this behavior of the printing sheet, the separating member can swing in the direction away from the fixing roller. Consequently, the printing sheet will gradually wrap around the fixing roller just beneath the separating member, eventually causing a paper jam.

### SUMMARY OF THE INVENTION

It is an object of the invention to provide a fixing device which will pose little risk of jams by preventing a printing sheet from going into a gap between a fixing roller and a separating member even when a large quantity of toner adheres to the printing sheet

In a first aspect of the invention, a fixing device intended to achieve the above object includes a fixing member, a pressure member pressed against the fixing member, a separating member disposed at a specific distance from the fixing member for separating a printing sheet therefrom after the printing sheet has passed through a nip portion formed between the fixing member and the pressure member, the separating member being made movable in directions toward and away from the fixing member, and a movement restricting member for limiting movement of the separating member in the direction away from the fixing member.

In a second aspect of the invention, an image forming apparatus includes an image transfer portion for transferring a toner image to a printing sheet, and a fixing device for fixing the toner image to the printing sheet, wherein the fixing device is configured in the same way as the fixing device of the aforementioned first aspect of the invention.

These and other objects, features and advantages of the invention will become more apparent upon reading the following detailed description along with the accompanying drawings.

### BRIEF DESCRIPTION OF THE DRAWINGS

FIG. 1 is a cross-sectional diagram showing the internal structure of an image forming apparatus including a fixing device according to a preferred embodiment of the invention;

FIG. 2 is an enlarged explanatory diagram of the fixing device;

FIG. 3 is a partially cutaway plan view showing a separating member, movement restricting members and a supporting plate supporting the separating member;

FIG. 4 is a cross-sectional diagram taken along lines IV-IV of FIG. 3; and

FIG. 5 is a cross-sectional diagram showing a state in which movement of the separating member is limited by movement restricting members according to a variation of the preferred embodiment.

### DETAILED DESCRIPTION OF THE PREFERRED EMBODIMENT

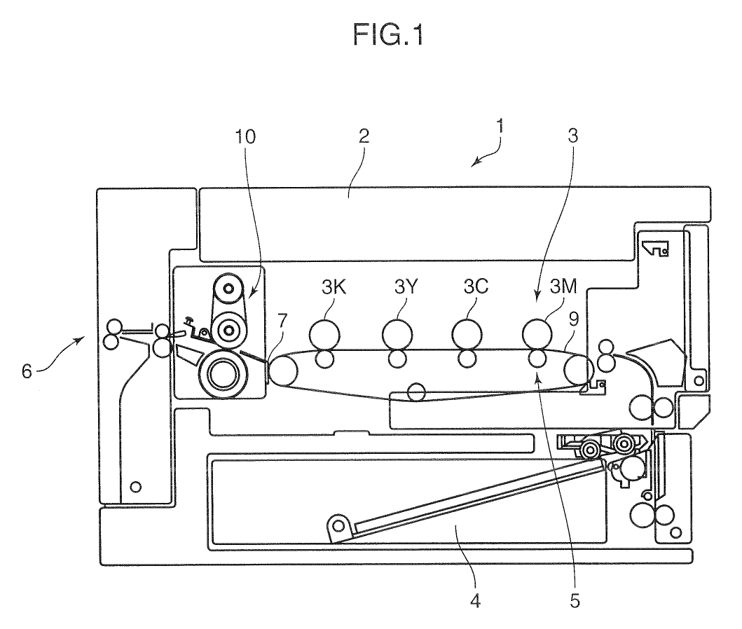

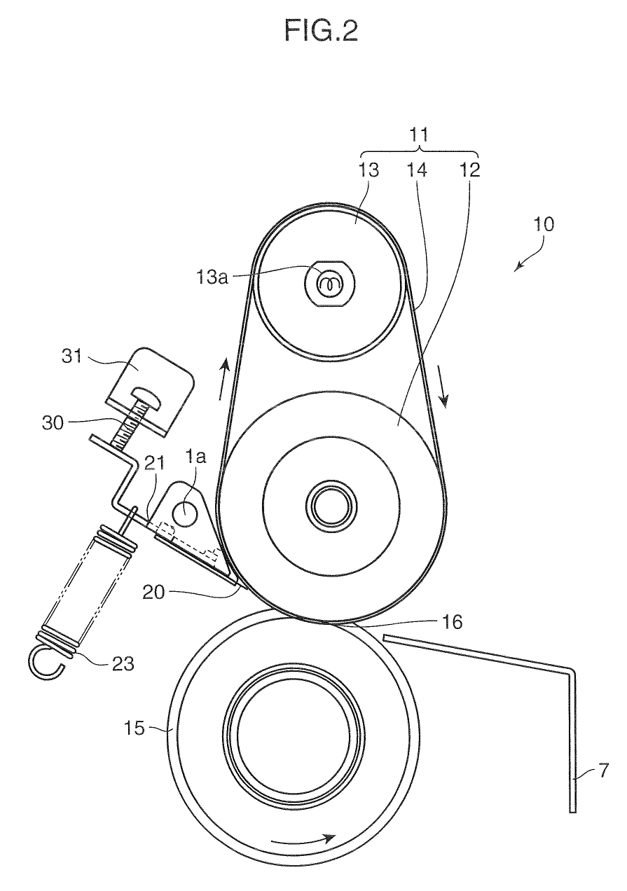

FIG. 1 is a cross-sectional diagram showing the internal structure of an image forming apparatus 1 including a fixing device 10 according to a preferred embodiment of the present invention, and FIG. 2 is an enlarged explanatory diagram of the fixing device 10. Firstly, the image forming apparatus 1 is generally described before dealing with details of the fixing device 10.

The image forming apparatus 1 of this embodiment is a color copying machine which includes an image reading portion 2 located at a topmost part, an image forming portion 3 (image transfer portion) for forming a toner image and transferring the toner image to a printing sheet, a sheet storage portion 4 for storing a plurality of printing sheets and the fixing device 10 for fixing the toner image to the printing sheet.

The image reading portion 2 acquires image information on an original to be copied by optically reading an original image. The image forming portion 3 forms the toner image based on the image information thus obtained. Located at a lower part of the image forming apparatus 1, the sheet storage portion 4 feeds each printing sheet to which the toner image is transferred toward the image forming portion 3.

Configured to permit color image forming, the image forming portion 3 includes an image forming mechanism having a magenta image forming unit 3M, a cyan image forming unit 3C, a yellow image forming unit 3Y and a black image forming unit 3K, a sheet transport belt 9 and an image transfer roller 5. Each of the image forming units 3M, 3C, 3Y, 3K is provided with a photosensitive drum on which an electrostatic latent image and a toner image are formed, a charging unit for uniformly charging an outer circumferential surface of the photosensitive drum, an exposure unit for projecting a laser beam on the outer circumferential surface of the photosensitive drum according to the image information acquired by the image reading portion 2, a developing unit for supplying toner to the outer circumferential surface of the photosensitive drum and a cleaning unit for cleaning the photosensitive drum, although the charging unit, the exposure unit, the developing unit and the cleaning unit are not illustrated.

The magenta image forming unit 3M, the cyan image forming unit 3C, the yellow image forming unit 3Y and the black image forming unit 3K are arranged in this order from an upstream side to a downstream side (right to left as illustrated) along a turning direction of the sheet transport belt 9 which transports the printing sheet. The printing sheet fed from the sheet storage portion 4 is transported by the sheet transport belt 9. As the printing sheet is transported by the sheet transport belt 9, magenta, cyan, yellow and black toner images are successively transferred from the respective photosensitive drums to the printing sheet one on top of another. The printing sheet carrying the transferred toner images which together form a color toner image is fed into the fixing device 10 via a guide plate 7. The fixing device 10 fixes the color toner image to the printing sheet by applying heat and pressure and the printing sheet carrying the fixed toner image is ejected to the exterior through a sheet output portion 6.

The fixing device 10 is now described in detail below. The fixing device 10 includes a fixing mechanism 11, a pressure roller 15 serving as a pressure member, a separating member 20 and movement restricting members 30 as depicted in FIG. 2. The fixing mechanism 11 is configured with a fixing roller 12, a supporting roller 13 and an endless fixing belt 14 mounted on the fixing roller 12 and the supporting roller 13.

The fixing roller 12 of this embodiment is configured with an iron core and a layer of silicone rubber formed around the ion core. The supporting roller 13 is configured with an aluminum core and an outer coating of Teflon (registered trademark of DuPont Company). The supporting roller 13 has a built-in heater 13a for heating the supporting roller 13 and the fixing belt 14 mounted thereon. The fixing belt 14 is configured with a nickel-based supporting structure covered with a layer of silicone rubber and a PFA (Perfluoroalkoxy) tube fitted on the silicone rubber layer to constitute a surface layer.

The pressure roller 15 is configured with an aluminum core covered with a layer of silicone rubber and a PFA tube fitted on the silicone rubber layer to constitute a surface layer. Located below the fixing roller 12, the pressure roller 15 is so disposed as to press against the fixing roller 12 via the fixing belt 14. Formed between the pressure roller 15 and the fixing roller 12 (fixing belt 14) is a nip portion 16 through which the printing sheet is passed.

The pressure roller 15 is driven by an electric motor (not shown) to rotate in a counterclockwise direction as illustrated in FIG. 2, causing the fixing belt 14 to turn in a clockwise direction. As a result, the printing sheet carrying the color toner image transferred thereto in the image forming portion 3 (image transfer portion) is fed downstream (right to left as shown in FIG. 2) toward the nip portion 16 between the pressure roller 15 and the fixing belt 14 by way of the guide plate 7. Then, as the printing sheet passes through the nip portion 16, the color toner image is fixed to the printing sheet by application of heat and pressure.

The fixing roller 12, the supporting roller 13 and the pressure roller 15 of this embodiment have generally the same length along an axial (front-to-rear) direction. Also, the width of the fixing belt 14 mounted on the fixing roller 12 and the supporting roller 13 as measured along the front-to-rear direction is made approximately equal to the length of the fixing roller 12 and the supporting roller 13 along the axial direction thereof.

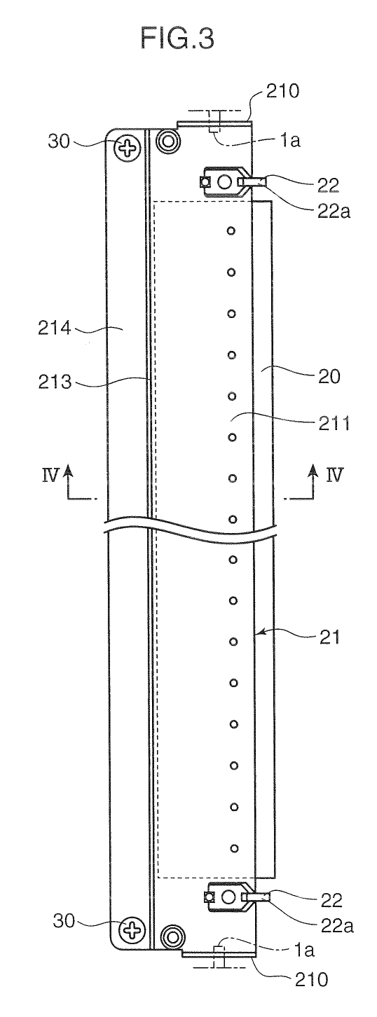

The separating member 20 is provided for separating the printing sheet which has passed through the nip portion 16 between the fixing belt 14 and the pressure roller 15 from the fixing roller 12. Referring to FIG. 3, the separating member 20 is made of a platelike member having approximately the same length (width) along the front-to-rear direction as the length of the fixing roller 12 along the axial direction thereof.

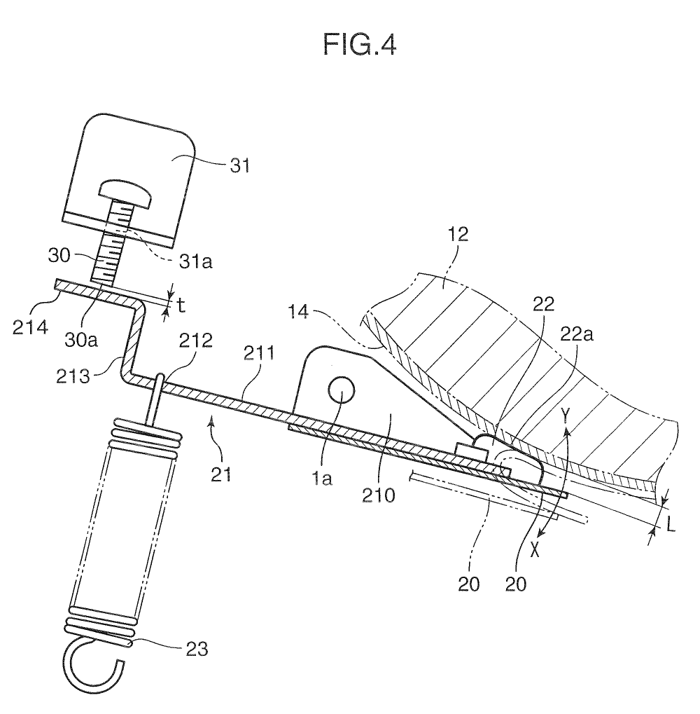

As shown in FIGS. 2 to 4, the separating member 20 is held by a supporting plate 21 which is pivotably supported by a pair of stationary pivot shafts 1a, so that the separating member 20 can move in directions toward and away from the fixing belt 14 (shown by “X” and “Y” in FIG. 4) as the supporting plate 21 pivots about the pivot shafts 1a. To be more specific, the supporting plate 21 is a platelike member having a slightly larger width than the separating member 20 and a specific length along the left-to-right direction, the supporting plate 21 including a flat portion 211 and a pair of bent portions 210 formed at left and right ends of the flat portion 211 as shown in FIG. 3. As depicted in FIGS. 2 and 4, the supporting plate 21 is pivotably supported by a pair of stationary pivot shafts la (supporting shafts) arranged parallel to a rotary shaft direction of the fixing roller 12, each of the pivot shafts la being fixed to a casing (not shown) of the image forming apparatus 1 approximately at the middle of the pertinent bent portion 210 in the left-to-right direction.

The separating member 20 is fixed to a bottom surface of the flat portion 211 of the supporting plate 21 by specific fixing means in such a manner that part of the separating member 20 extends from the supporting plate 21 beyond a right edge thereof as shown in FIG. 3, wherein the fixing means may be screws, welding or adhesive bonding, for example. With this arrangement, the separating member 20 moves in the direction away from the fixing belt 14 (shown by “X” in FIG. 4) when the supporting plate 21 swings in the clockwise direction (first direction) as illustrated in FIG. 4. Contrary to this, the separating member 20 moves in the direction toward the fixing belt 14 (shown by “Y” in FIG. 4) when the supporting plate 21 swings in the counterclockwise direction (second direction) as illustrated in FIG. 4.

As shown in FIG. 3, the supporting plate 21 is provided with a pair of retaining members 22 fixedly attached to the supporting plate 21 close to front and rear ends thereof, each of the retaining members 22 having a contact surface 22a. The retaining members 22 are forced against the fixing roller 12 to keep the separating member 20 approximately at a fixed distance from the fixing roller 12 at all times. More specifically, the retaining members 22 have the respective contact surfaces 22a facing the fixing belt 14 and, as these contact surfaces 22a go into contact with the fixing belt 14, the retaining members 22 ensure that the distance L between the separating member 20 and the fixing belt 14 does not become smaller than a fixed value as shown in FIG. 4.

The supporting plate 21 is further provided with a biasing member 23 made of a coil spring of which upper end is connected to a hooking part 212 provided close to a left end of the supporting plate 21 and lower end is connected to the unillustrated casing of the image forming apparatus 1.

With this arrangement, a left-hand part of the supporting plate 21 is always pulled downward, or biased in the counterclockwise direction, by the biasing member 23 as shown in FIG. 4, so that the separating member 20 is biased in the direction toward the fixing belt 14 (shown by “Y” in FIG. 4). As the supporting plate 21 (separating member 20) is biased in this way, the contact surfaces 22a of the retaining members 22 remain in continuous contact with the fixing belt 14 and the distance L between the separating member 20 and the fixing belt 14 is always kept at the fixed value.

Next, the aforementioned movement restricting members 30 are explained. The movement restricting members 30 serve to limit movement of the separating member 20 in the direction away from the fixing belt 14 (shown by “X” in FIG. 4). Specifically, the movement restricting members 30 of this embodiment limit the movement of the separating member 20 in the receding direction thereof by restricting swing motion of the supporting plate 21 in the clockwise direction in this embodiment.

The movement restricting members 30 used in this embodiment are bolts made of a metallic material. Each of the movement restricting members 30 has at a lower end thereof a contact part 30a which goes into contact with part of the supporting plate 21. Specifically, the supporting plate 21 has a vertical bent portion 213 extending generally upward from a left end of the flat portion 211 and a horizontal bent portion 214 extending generally horizontally from the vertical bent portion 213. The movement restricting members 30 are disposed such that the contact parts 30a thereof can go into contact with the horizontal bent portion 214 of the supporting plate 21.

The individual movement restricting members 30 are supported by bolt supporting brackets 31 fixed to the casing of the image forming apparatus 1, the bolt supporting brackets 31 having threaded holes 31a in which the movement restricting members 30 can be fitted. It is to be noted that the bolt supporting brackets 31 are not illustrated in FIG. 3. The contact parts 30a of the individual movement restricting members 30 can be moved generally vertically closer to and apart from the horizontal bent portion 214 of the supporting plate 21 by turning the movement restricting members 30 in the threaded holes 31a. Each of the movement restricting members 30 is arranged such that a specific gap t is formed between the contact part 30a and the horizontal bent portion 214 of the supporting plate 21.

Next, the working of the fixing device 10 of the embodiment is explained. A biasing force exerted by the biasing member 23 keeps the contact surfaces 22a of the retaining members 22 in continuous contact with the fixing belt 14 mounted on the fixing roller 12 as shown in FIG. 4. In this condition, the distance L between the separating member 20 and the fixing belt 14 is always kept at the fixed value.

If abnormal rotation of the fixing roller 12, such as fluctuation of a rotary axis thereof, occurs due to a machining error or deformation, it would be required to turn the supporting plate 21 in the clockwise or counterclockwise direction by an amount necessary for eliminating an adverse effect of the fluctuation of the rotary axis, for example. In this embodiment, there is formed the specific gap t between the contact part 30a of each movement restricting member 30 and the horizontal bent portion 214 of the supporting plate 21 as mentioned above, so that it is possible to turn the supporting plate 21 in the clockwise or counterclockwise direction by the amount necessary for eliminating the adverse effect of the fluctuation of the rotary axis of the fixing roller 12 without causing the contact part 30a of each movement restricting member 30 to contact the horizontal bent portion 214 of the supporting plate 21. This makes it possible to always keep the distance L between the separating member 20 and the fixing belt 14 at the fixed value without being hindered by the movement restricting members 30.

The printing sheet carrying the color toner image transferred thereto in the image forming portion 3 (image transfer portion) is fed downstream from right to left through the nip portion 16 between the pressure roller 15 and the fixing belt 14 as illustrated in FIG. 1 by way of the guide plate 7. The color toner image on the printing sheet is fixed thereto by application of heat and pressure at the nip portion 16.

Subsequently, the printing sheet carrying the color toner image fixed thereto is peeled off from the fixing belt 14 by the separating member 20 and the printing sheet thus separated is ejected to the output portion 6. When a large quantity of toner adheres to the printing sheet or the toner has high tackiness, a mid-length part of the printing sheet may become bent in a U-shape and go into a gap between the fixing belt 14 and the separating member 20 as shown by alternate long and two short dashed lines in FIG. 4 even if a leading edge of the printing sheet is peeled off from the fixing belt 14 by the separating member 20. This behavior of the printing sheet could cause the supporting plate 21 to swing in the clockwise direction about the pivot shafts 1a, forcing the separating member 20 in the direction away from the fixing belt 14.

In the above-described arrangement of the embodiment, however, the horizontal bent portion 214 of the supporting plate 21 interferes with the contact parts 30a of the movement restricting members 30 when the supporting plate 21 turns in the clockwise direction so that the swing motion of the supporting plate 21 in the clockwise direction is restricted. This ensures that the mid-length part of the printing sheet would not easily go into the gap between the fixing belt 14 and the separating member 20, substantially reducing the risk of jams.

While the invention has been described with reference to the preferred embodiment thereof, the above-described arrangement of the embodiment is simply illustrative and may be modified in various ways. Cited under (1) to (5) below are some examples of such modifications of the embodiment.

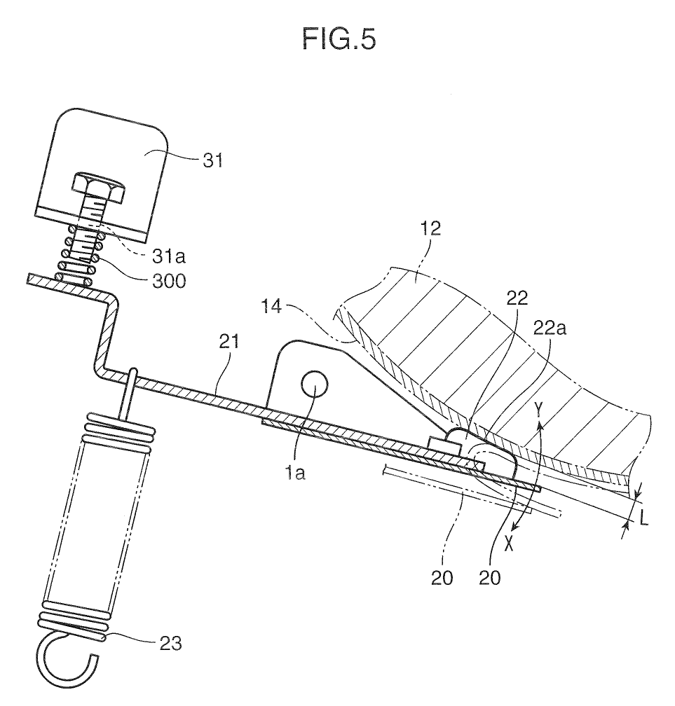

(1) While the movement restricting members 30 used in the foregoing embodiment are bolts made of a metallic material, this arrangement may be modified as appropriate. For example, movement restricting members 300 made of elastic members having elasticity, such as coil springs or synthetic rubber elements, may be used instead as shown in FIG. 5 (which shows an arrangement using coil springs).

If the movement restricting members 300 made of this kind of elastic members are used, it is possible to cause the supporting plate 21 to swing in the clockwise direction overwhelming the elasticity of the movement restricting members 300 to a certain extent even when the movement restricting members 300 are in contact with the horizontal bent portion 214 of the supporting plate 21. Therefore, even if the fixing belt 14 with which the retaining members 22 are in contact oscillates, it is possible to cause the supporting plate 21 to swing in the clockwise or counterclockwise direction and thereby absorb oscillatory motion of the fixing belt 14, for instance.

In this modification of the embodiment, the movement restricting members 300 are to be kept in continuous contact with the supporting plate 21, for example, and it is not necessary to provide the gap t between each movement restricting member 30 (metallic bolt) and the horizontal bent portion 214 of the supporting plate 21 as shown in FIG. 4. Thus, adjustment of the movement restricting members 300, such as positioning thereof with respect to the supporting plate 21, can be made easier in this modification.

(2) In the arrangement of the embodiment using the movement restricting members 30 made of metallic bolts having no elasticity, the gap t between the contact part 30a of each movement restricting member 30 and the horizontal bent portion 214 of the supporting plate 21 (refer to FIG. 4) is not limited to a particular value. Additionally, it is not necessarily needed to create the gap t but the contact part 30a of each movement restricting member 30 may be kept in contact with the horizontal bent portion 214 of the supporting plate 21.

(3) In the foregoing embodiment, the fixing mechanism 11 includes the fixing roller 12, the supporting roller 13 and the fixing belt 14. This arrangement may be modified such that the fixing mechanism 11 includes only the fixing roller 12, for example, or otherwise modified as appropriate.

(4) While each of the retaining members 22 is held in contact with the fixing belt 14 in the foregoing preferred embodiment, the invention is not limited to this arrangement. For example, the embodiment may be so modified as to keep each of the retaining members 22 in contact with part of the iron core of the fixing roller 12 or in another fashion as appropriate.

(5) While the foregoing embodiment has illustrated an example in which the fixing device of the present invention is applied to the color copying machine, the invention is not limited to this example. The fixing device of the embodiment or a modification thereof is similarly applicable not only to a color printer, a facsimile machine or a hybrid apparatus thereof but also to a monochrome copying machine.

While the invention has thus far been described with reference to the illustrative embodiment and the modifications thereof, principal arrangements and features of the invention can be summarized as follows.

According to one aspect of the invention, a fixing device includes a fixing member, a pressure member pressed against the fixing member, a separating member disposed at a specific distance from the fixing member for separating a printing sheet therefrom after the printing sheet has passed through a nip portion formed between the fixing member and the pressure member, the separating member being made movable in directions toward and away from the fixing member, and a movement restricting member for limiting movement of the separating member in the direction away from the fixing member.

In the fixing device thus configured, the movement restricting member limits the movement of the separating member in the direction away from the fixing member. This arrangement keeps the gap between the fixing member and the separating member from becoming larger than a preset value, thereby ensuring that the printing sheet would not easily go into the gap between the fixing member and the separating member. This makes it possible to prevent the printing sheet from bending in a U-shape and going into the gap between the fixing member and the separating member as in the conventional fixing device even when the printing sheet can not be easily peeled off from the fixing member with a large quantity of toner adhering to the printing sheet or the toner having high tackiness. It is therefore possible to smoothly peel off the printing sheet from the fixing member, substantially reducing the risk of jams.

Preferably, the aforementioned fixing device further comprises a supporting member for supporting the separating member, the supporting member being held pivotably about a pivot shaft which is parallel to an axial direction of the fixing member, wherein the separating member moves in the direction away from the fixing member when the supporting member is pivoted in a first direction about the pivot shaft, and the separating member moves in the direction toward the fixing member when the supporting member is pivoted in a second direction opposite to the first direction about the pivot shaft. The fixing device thus configured makes it possible to easily move the separating member by swinging the supporting member about the pivot shaft.

Preferably, the aforementioned fixing device further comprises a retaining member provided on the supporting member, the retaining member being held in contact with the fixing member to keep the separating member approximately at a fixed distance from the fixing member at all times, and a biasing member for biasing the supporting member in the second direction so that the retaining member remains in continuous contact with the fixing member. This configuration serves to hold the separating member at a fixed position relative to the fixing member in a stable fashion.

Preferably, the aforementioned movement restricting member is a member which interferes with part of the supporting member when the supporting member is pivoted by a specific amount in the first direction. In the fixing device thus configured, the movement restricting member interferes with part of the supporting member so that the movement of the separating member can be limited by a simple structure in a reliable fashion.

Still preferably, the movement restricting member has elasticity, and the supporting member pushes against the movement restricting member, overwhelming the elasticity thereof, when pivoted in the first direction.

In the fixing device thus configured, it is possible to cause the supporting member to pivot in one direction, overwhelming the elasticity of the movement restricting member, even when the movement restricting member is in contact with the supporting member, for instance. Therefore, even if the fixing member with which the retaining member is in contact oscillates due to a machining error or deformation, for instance, it is possible to cause the supporting member to swing in both of the two opposite directions (first and second directions) and thereby absorb oscillatory motion of the fixing member This means that the movement restricting member is to be kept in continuous contact with the supporting member for example, so that adjustment of the movement restricting member, such as positioning thereof with respect to the supporting member, can be made easier.

According to another aspect of the invention, an image forming apparatus includes an image transfer portion for transferring a toner image to a printing sheet, and a fixing device for fixing the toner image to the printing sheet, the fixing device including a fixing member, a pressure member pressed against the fixing member, a separating member disposed at a specific distance from the fixing member for separating the printing sheet therefrom after the printing sheet has passed through a nip portion formed between the fixing member and the pressure member, the separating member being made movable in directions toward and away from the fixing member, and a movement restricting member for limiting movement of the separating member in the direction away from the fixing member.

This configuration makes it possible to provide an image forming apparatus of which fixing device poses little risk of jams.

This application is based on Japanese Patent application serial No. 2008-187195 filed in Japan Patent Office on Jul. 18, 2008, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. A fixing device comprising:
a fixing member;
a pressure member pressed against said fixing member;
a separating member disposed at a specific distance from said fixing member for separating a printing sheet therefrom after the printing sheet has passed through a nip portion formed between said fixing member and said pressure member, said separating member being made movable in directions toward and away from said fixing member; and
a movement restricting member for limiting movement of said separating member in the direction away from said fixing member.

2. The fixing device according to claim 1 further comprising a supporting member for supporting said separating member, said supporting member being held pivotably about a pivot shaft which is parallel to an axial direction of said fixing member, wherein said separating member moves in the direction away from said fixing member when said supporting member is pivoted in a first direction about the pivot shaft, and said separating member moves in the direction toward said fixing member when said supporting member is pivoted in a second direction opposite to the first direction about the pivot shaft.

3. The fixing device according to claim 2 further comprising:
a retaining member provided on said supporting member, said retaining member being held in contact with said fixing member to keep said separating member approximately at a fixed distance from said fixing member at all times; and
a biasing member for biasing said supporting member in the second direction so that said retaining member remains in continuous contact with said fixing member.

4. The fixing device according to claim 3 wherein said movement restricting member is a member which interferes with part of said supporting member when said supporting member is pivoted by a specific amount in the first direction.

5. The fixing device according to claim 3 wherein said movement restricting member has elasticity, and said supporting member pushes against said movement restricting member, overwhelming the elasticity thereof, when pivoted in the first direction.

6. An image forming apparatus comprising:
an image transfer portion for transferring a toner image to a printing sheet; and
a fixing device for fixing the toner image to the printing sheet, said fixing device including:
a fixing member;
a pressure member pressed against said fixing member;
a separating member disposed at a specific distance from said fixing member for separating the printing sheet therefrom after the printing sheet has passed through a nip portion formed between said fixing member and said pressure member, said separating member being made movable in directions toward and away from said fixing member; and
a movement restricting member for limiting movement of said separating member in the direction away from said fixing member.

7. The image forming apparatus according to claim 6 further comprising a supporting member for supporting said separating member, said supporting member being held pivotably about a pivot shaft which is parallel to an axial direction of said fixing member, wherein said separating member moves in the direction away from said fixing member when said supporting member is pivoted in a first direction about the pivot shaft, and said separating member moves in the direction toward said fixing member when said supporting member is pivoted in a second direction opposite to the first direction about the pivot shaft.

8. The image forming apparatus according to claim 7 further comprising:
a retaining member provided on said supporting member, said retaining member being held in contact with said fixing member to keep said separating member approximately at a fixed distance from said fixing member at all times; and
a biasing member for biasing said supporting member in the second direction so that said retaining member remains in continuous contact with said fixing member.

9. The image forming apparatus according to claim 8 wherein said movement restricting member is a member which interferes with part of said supporting member when said supporting member is pivoted by a specific amount in the first direction.

10. The image forming apparatus according to claim 8 wherein said movement restricting member has elasticity, and said supporting member pushes against said movement restricting member, overwhelming the elasticity thereof, when pivoted in the first direction.
